(19) United States
(12) Patent Application Publication
(10) Pub. No.: US 2004/0179972 A1
(43) Pub. Date: Sep. 16, 2004

(54) Systems and methods for detecting manufacturing defects in microfluidic devices

(75) Inventors: Christoph D. Karp, Pasadena, CA (US); Marci Pezzuto, Altadena, CA (US)

Correspondence Address: NANOSTREAM, INC., 580 SIERRA MADRE VILLA AVE., PASADENA, CA, 91107-2928, US

(73) Assignee: Nanostream, Inc.

(21) Appl. No.: 10/798,011

(22) Filed: Mar. 10, 2004

Related U.S. Application Data
(60) Provisional application No. 60/454,968, filed on Mar. 14, 2003.

(51) Int. Cl. B01L 3/02

(52) U.S. Cl. 422/100

(57) ABSTRACT

Microfluidic devices including one or more microstructures adapted to provide an indication of the extent and severity of collapse of channels and other microstructures within the device are provided. The channel collapse test structures do not communicate with operational structures of the device, but are positioned and adapted to provide an indication of the structural integrity of similarly dimensioned operational structures.

### STATEMENT OF RELATED APPLICATION(S)

This application claims benefit of commonly assigned U.S. provisional patent application serial No. 60/454,968 filed Mar. 14, 2003 and currently pending.

### FIELD OF THE INVENTION

The present invention relates to the design and fabrication of microfluidic devices.

### BACKGROUND OF THE INVENTION

There has been a growing interest in the manufacture and use of microfluidic systems for the acquisition of chemical and biological information. In particular, when conducted in microfluidic volumes, complex chemical and biochemical reactions may be carried out using very small volumes of liquid. Among other benefits, microfluidic systems improve the response time of reactions, minimize sample volume, and lower reagent consumption. When volatile or hazardous materials are used or generated, performing reactions in microfluidic volumes also enhances safety and reduces disposal quantities.

Traditionally, microfluidic devices have been constructed in a planar fashion using techniques that are borrowed from the silicon fabrication industry. Representative systems are described, for example, in some early work by Manz et al. (Trends in Anal. Chem. (1990) 10(5): 144-149; Advances in Chromatography (1993) 33: 1-66). In these publications, microfluidic devices are constructed by using photolithography to define channels on silicon or glass substrates and etching techniques to remove material from the substrate to form the channels. A cover plate is bonded to the top of the device to provide closure. Miniature pumps and valves can also be constructed to be integral (e.g., within) such devices. Alternatively, separate or off-line pumping mechanisms are contemplated.

More recently, a number of methods have been developed that allow microfluidic devices to be constructed from plastic, silicone or other polymeric materials. In one such method, a negative mold is first constructed, and plastic or silicone is then poured into or over the mold. The mold can be constructed using a silicon wafer (see, e.g., Duffy et al., Analytical Chemistry (1998) 70: 4974-4984; McCormick et. al., Analytical Chemistry (1997) 69: 2626-2630), or by building a traditional injection molding cavity for plastic devices. Some molding facilities have developed techniques to construct extremely small molds. Components constructed using a LIGA technique have been developed at the Karolsruhe Nuclear Research center in Germany (see, e.g., Schomburg et al., Journal of Micromechanical Microengineering (1994) 4: 186-191), and commercialized by MicroParts (Dortmund, Germany). Jenoptik (Jena, Germany) also uses LIGA and a hot-embossing technique. Imprinting methods in PMMA have also been demonstrated (see, Martynova et.al., Analytical Chemistry (1997) 69: 4783-4789). However, these techniques do not lend themselves to rapid prototyping and manufacturing flexibility. Additionally, the foregoing references teach only the preparation of planar microfluidic structures. Moreover, the tool-up costs for both of these techniques are quite high and can be cost-prohibitive.

A more recent method for constructing microfluidic devices uses a KrF laser to perform bulk laser ablation in fluorocarbons that have been compounded with carbon black to cause the fluorocarbon to be absorptive of the KrF laser (see, e.g., McNeely et al., “Hydrophobic Microfluidics,” SPIE Microfluidic Devices & Systems IV, Vol. 3877 (1999)). This method is reported to reduce prototyping time; however, the addition of carbon black renders the material optically impure and presents potential chemical compatibility issues. Additionally, the reference is directed only to planar structures.

In another method proposed for fabricating microfluidic devices, a plurality of stacked device layers or sheets define microfluidic structures within the device that form channels and/or other microstructures. The channels are defined in one or more of the device layers by cutting or otherwise removing portions of the device layer such that the remaining portions of the device layer form the lateral boundaries or “walls” of the microstructures. The microstructures are completed by sandwiching the device layer between substrates and/or other device layers to form the “floors” and “ceilings” of the microstructures. The use of multi-layer construction permits robust devices to be fabricated quickly and inexpensively compared to surface micromachining or material deposition techniques that are conventionally employed to produce microfluidic devices.

One difficulty associated with the use of multi-layer construction is that many of the materials used to fabricate microfluidic devices may be susceptible to dimensional variation during assembly of the device. For instance, the application of heat and/or pressure during the fabrication process may cause certain polymers, such as polypropylene, to contract, shrink, or deform. As a consequence, the channels, chambers, and other microstructures formed within the layers may sag, collapse, or otherwise become partially or completely occluded (hereinafter referred to collectively as “collapse”). While the total collapse of a feature may be visually evident, partial occlusion of features may be more difficult to assess visually. In either case, however, the performance of the microfluidic device may be degraded. Thus, it would be desirable to identify the presence and quantify the degree of collapse of structures within a microfluidic device.

While collapse within a device may be minimized by controlling pressure and temperature profiles applied during the assembly process, the natural variation in the properties of raw materials and the error inherent in any control systems may result in enough variation to cause undesirable levels of channel collapse. Thus, it is important to monitor the degree or extent of any such channel collapse to provide feedback to the control process to accommodate for control error and inconsistent raw materials. Typically, such monitoring is conducted by removing selected devices from the fabrication process and destructively testing them to quantify the degree of channel collapse.

This approach is limited, however, because it results in the destruction of some percentage of the production output. Moreover, any such sampling results only in a statistical analysis of the production process and also is subject to error, particularly if only a small number of devices are sampled to maximize the quantity of devices produced.

Thus, it would be desirable to provide non-destructive systems and methods for detecting channel collapse in microfluidic devices. It would also be desirable to provide non-destructive systems and methods for detecting channel collapse in microfluidic devices that may be used with every device without the need for sampling or other statistical methods.

### BRIEF DESCRIPTION OF THE DRAWINGS

FIG. 1A is a top view of a channel collapse test structure in a first state of relatively insignificant collapse.

FIG. 1B is a cross-sectional view of the channel collapse test structure of FIG. 1A taken along section line “A”-“A”.

FIG. 2A is a top view of the channel collapse test structure for FIG. 1A in a second state of collapse.

FIG. 2B is a cross-sectional view of the channel collapse test structure of FIG. 2A taken along section line “B”-“B”.

FIG. 3A is a top view of the channel collapse test structure for FIG. 1A in a third state of collapse.

FIG. 3B is a cross-sectional view of the channel collapse test structure of FIG. 3A taken along section line “C”-“C”.

FIG. 3C is a cross-sectional view of the channel collapse test structure of FIG. 3A taken along section line “D”-“D”.

FIG. 3D is a cross-sectional view of the channel collapse test structure of FIG. 3A taken along section line “E”-“E”.

FIG. 3E is a cross-sectional view of the channel collapse test structure of FIG. 3A taken along section line “F”-“F”.

FIG. 4A is a cross-sectional view of a channel collapse test structure according to the present invention in a first state of collapse.

FIG. 4B is a cross-sectional view of the channel collapse test structure of FIG. 4A in a second state of collapse.

FIG. 5A is a cross-sectional view of a channel collapse test structure in a first state of collapse.

FIG. 5B is a cross-sectional view of the channel collapse test structure of FIG. 5A in a second state of collapse.

FIG. 6 is a top view of a portion of a plurality of partially collapsed microfluidic channels containing a test fluid.

FIG. 7 is a top view of a multi-layer, three-dimensional microfluidic device according to one embodiment of the present invention.

### DETAILED DESCRIPTION OF PREFERRED EMBODIMENTS OF THE INVENTION

Definitions

The terms “channel” or “chamber” as used herein are to be interpreted in a broad sense. Thus, they are not intended to be restricted to elongated configurations where the transverse or longitudinal dimension greatly exceeds the diameter or cross-sectional dimension. Rather, such terms are meant to comprise cavities or tunnels of any desired shape or configuration through which liquids may be directed. Such a fluid cavity may, for example, comprise a flow-through cell where fluid is to be continually passed or, alternatively, a chamber for holding a specified, discrete ratio of fluid for a specified ratio of time. “Channels” and “chambers” may be filled or may contain internal structures comprising, for example, valves, filters, and similar or equivalent components and materials.

The term “operational microfluidic structure” as used herein refers to any microfluidic structure within a microfluidic device that performs an operation on fluids introduced into the device. For example, functional features may include, but are not limited to, channels or vias for conducting fluid, mixers, separation channels, reaction chambers, analysis windows, and other useful structures known in the art.

The terms “stencil” or “stencil layer” as used herein refer to a material layer or sheet that is preferably substantially planar, through which one or more variously shaped and oriented channels have been cut or otherwise removed through the entire thickness of the layer, thus permitting substantial fluid movement within the layer (as opposed to simple through-holes for transmitting fluid through one layer to another layer). The outlines of the cut or otherwise removed portions form the lateral boundaries of microstructures that are completed when a stencil is sandwiched between other layers, such as substrates and/or other stencils. Stencil layers can be either substantially rigid or flexible (thus permitting one or more layers to be manipulated so as not to lie in a plane).

Microfluidic Devices Generally

In an especially preferred embodiment, microfluidic devices according to the present invention are constructed using stencil layers or sheets to define channels and/or chambers. As noted previously, a stencil layer is preferably substantially planar and has a channel or chamber cut through the entire thickness of the layer to permit substantial fluid movement within that layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permits robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including polymeric, metallic, and/or composite materials, to name a few. Various preferred embodiments utilize porous materials including filter materials. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties. For instance, particularly desirable polymers include polyolefins, more specifically polypropylenes, and vinyl-based polymers.

Various means may be used to seal or bond layers of a device together. For example, adhesives may be used. In one embodiment, one or more layers of a device may be fabricated from single- or double-sided adhesive tape, although other methods of adhering stencil layers may be used. Portions of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thickness of these carrier materials and adhesives may be varied.

Device layers may be directly bonded without using adhesives to provide high bond strength (which is especially desirable for high-pressure applications) and eliminate potential compatibility problems between such adhesives and solvents and/or samples. Specific examples of methods for directly bonding layers of non-biaxially-oriented polypropylene to form stencil-based microfluidic structures are disclosed in co-pending U.S. Provisional Patent Application Serial Nos. 60/338,286 (filed Dec. 6, 2001) and 60/393,953 (filed Jul. 2, 2002), which are commonly owned by assignee of the present application and incorporated by reference as if fully set forth herein. In one embodiment, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately five hours at a temperature of 154° C. to yield a permanently bonded microstructure well-suited for use with high-pressure column packing methods. In another embodiment, multiple layers of 7.5-mil (188 micron) thickness “Clear Tear Seal” polypropylene (American Profol, Cedar Rapids, Iowa) including at least one stencil layer may be stacked together. Several microfluidic device assemblies may be stacked together, with a thin foil disposed between each device. The stack may then be placed between insulating platens, heated at 152° C. for about 5 hours, cooled with a forced flow of ambient air for at least about 30 minutes, heated again at 146° C. for about 15 hours, and then cooled in a manner identical to the first cooling step. During each heating step, a pressure of about 0.37 psi (2.55 kPa) is applied to the microfluidic devices.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

Further embodiments may be fabricated from various materials using well-known techniques such as embossing, stamping, molding, and soft lithography.

In addition to the use of adhesives and the adhesiveless bonding method discussed above, other techniques may be used to attach one or more of the various layers of microfluidic devices useful with the present invention, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

Preferred Embodiments

Microfluidic devices according to the present invention include one or more microstructures adapted to provide an indication of the extent and severity of collapse of operational microfluidic structures within the device. Such channel collapse test structures or “detection channels” do not communicate with operational microfluidic structures of the device, but are positioned and adapted to provide an indication of the structural integrity of similarly dimensioned operational microfluidic structures.

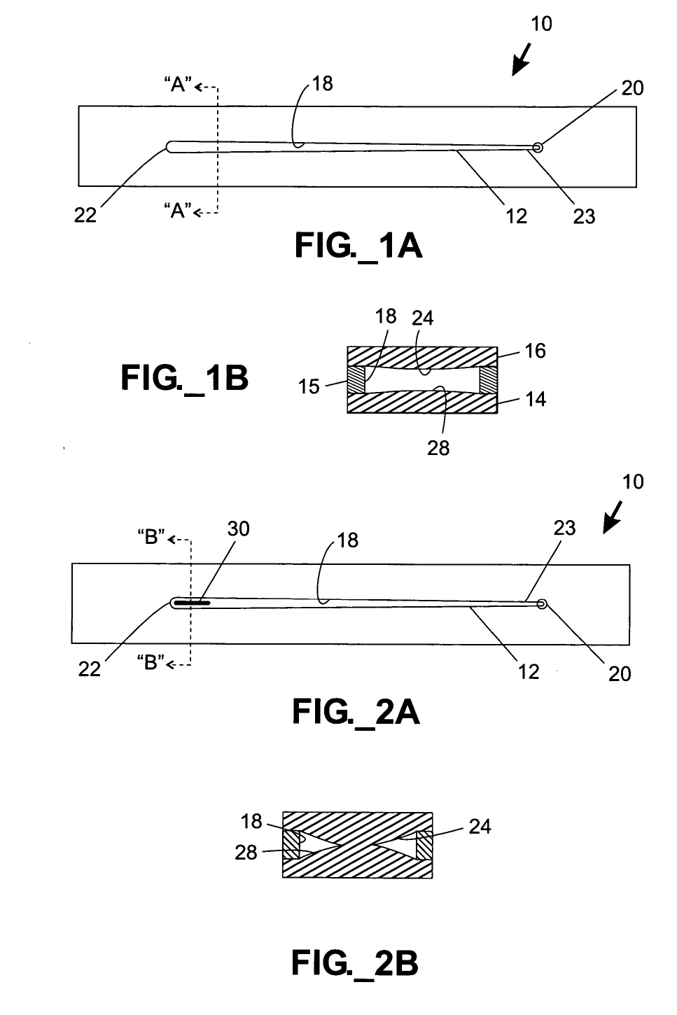

FIGS. 1A-1B illustrate a simple multi-layer device 10 having a detection channel 18. The device 10 comprises three device layers 14-16. The detection channel 18 is defined in the second device layer 15, which also is a stencil layer, and is characterized by a variable width from a wide end 22 to a narrow end 23. A vent 20 may be defined in the third device layer 16 to allow gases trapped in the channel 18 to escape during the fabrication process.

The variation in width of the detection channel 18 may be selected to ensure that the wide end 22 is sufficiently wide to permit at least some channel collapse and the narrow end 23 is sufficiently narrow to permit substantially no collapse. In this manner, collapse of the detection channel 18 should be detected in varying degrees along the length of the channel 18 in correlation with the width thereof. An operator may then correlate the length of the collapsed portion of the channel 18 and the likelihood that other features within the device also have experienced collapse. In other words, the distance that the collapse extends down the detection channel 18 shows the extent of sag at the smaller channel dimensions.

For example, FIGS. 1A-1B, 2A-2B, and 3A-3E illustrate the detection channel 18 in various states of collapse. In FIG. 1A the detection channel 18 appears completely transparent. Referring to FIG. 1B, examination of the channel 18 in cross-section reveals some slight sag or collapse of the ceiling 24 and the floor 28 into the channel 18; however, the ceiling 24 and floor 28 do not come into contact. Thus, in FIGS. 1A-1B, there is no outwardly visible collapse.

In comparison, FIG. 2A illustrates a case where the detection channel 18 has a collapsed area 30 (which would appear visibly as a translucent or opaque area). Referring to FIG. 2B, examination of a cross-section of the collapsed area 30 reveals complete collapse of the channel in this region, i.e., the ceiling 24 is in contact with the floor 28 of the channel 18.

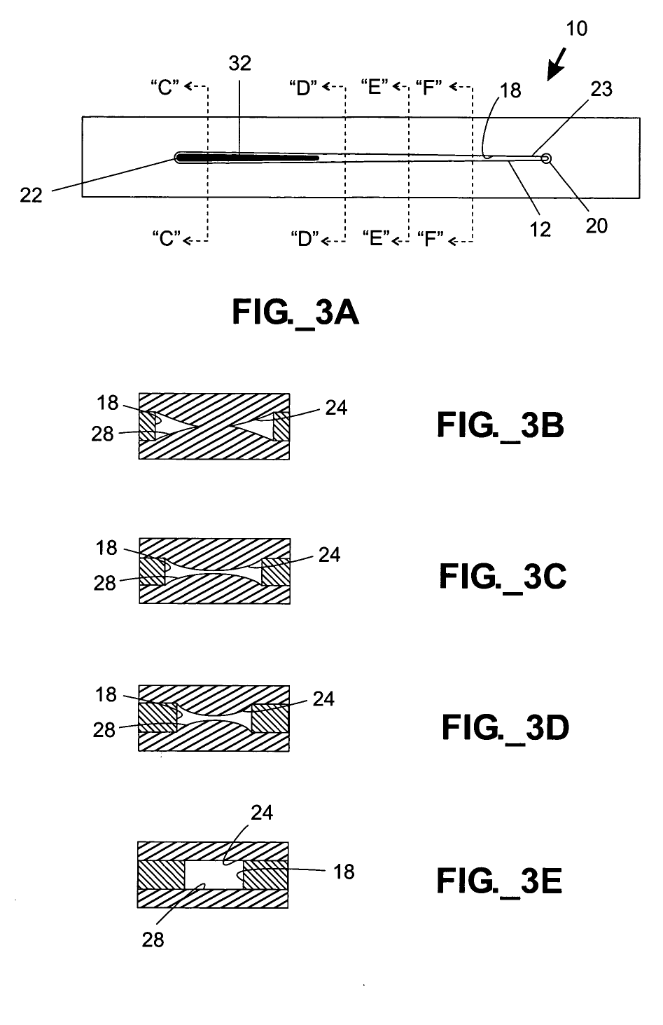

In another example, shown in FIG. 3A, a larger collapsed area 30 is evident in the detection channel 18. Referring to FIGS. 3B-3E, examination of cross-sections of the collapsed area 32 and other regions of the channel 18 reveals channel failure ranging from a collapse of the channel 18 (i.e., the ceiling 24 is in contact with the floor 28) to a partially occluded channel (i.e., the ceiling 24 and floor 28 are not in contact, but substantially sag into the channel, reducing the volume thereof) to a region showing no significant channel collapse.

In practice, an operator examining microfluidic devices having detection channels in the various conditions described in FIGS. 1A-1B, 2A-2-B, or 3A-3E could conclude that devices showing characteristics similar to those illustrated in FIGS. 1A-1B suffered from little or no channel collapse; devices showing characteristics similar to those illustrated in FIGS. 2A-2B suffered from minor or limited channel collapse; and devices showing characteristics similar to those illustrated in FIGS. 3A-3E suffered from significant or substantial channel collapse.

Further quantification of the correlation between the degree of collapse in the detection channel 18 and other microstructures, features or channels in a device may be achieved by performing destructive testing of the devices during the initial production period of the device. For example, the length and/or area of the collapsed area 30 within the detection channel 18 is proportional to the degree of sag or collapse of other structures within the device. By performing validation studies of each device design, a more precise quantification of the proportionality may be determined. Once such correlations have been established for a particular device, an operator could measure the length of a collapsed area in a detection channel and determine the amount of sag and/or collapse within other structures in the device. In this manner, microfluidic devices suffering from collapse, but nonetheless retaining sufficient structural integrity to perform within established tolerances, could be operated without inducing unacceptable levels of error.

Other detection channel structures also may be provided. For instance, in one embodiment, a series of channel segments each have a constant width that differs from the width of other such segments. Likewise, a series of circular regions having different diameters may be used. As will be readily appreciated by one skilled in the art, any detection structure(s) having a variation in width (either continuous variation along a single feature or variation among a series of discrete features) may be used to provide an indication of the degree of collapse present in a given device.

Even if a channel does not suffer from complete collapse, it may be desirable to determine the degree of sag that has occurred within the device. For example, in some devices, the volume of a particular channel may be significant for performing metering operations or establishing a desired flow rate. As shown in FIGS. 1A-1B, however, there may be sag within a channel 18 even when there is no collapsed region. Because sag without complete collapse may not be visible to the naked eye, even in a detection channel 18, it may be desirable to provide features and instrumentation to reveal the amount of sag.

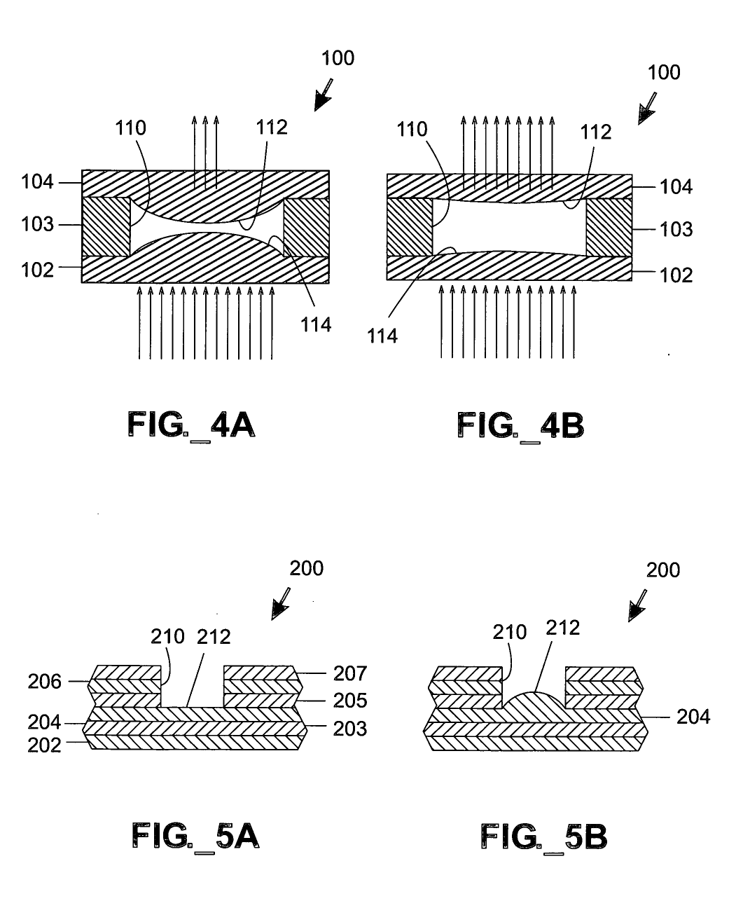

In one embodiment, where optically transmissive device layers are used, the “lensing” effect of the material as it sags may be used to identify and quantify channel sag. For example, referring to FIGS. 4A-4B, a device 100 comprises three device layers 102-104. Device layer 103 defines a detection channel 110 bounded by device layer 104 (which forms the ceiling 112) and device layer 102 (which forms the floor 114). Light may be directed through the device 100 at the region of the channel 110. If any sag is present, the floor 114 and ceiling 112 of the channel 110 will act like lenses and refract the light passing therethrough. The amount of refraction is proportional to the amount of sag within the channel 110. An optical detector (not shown) may be used to measure the refraction and, thus, the degree of sag in the channel 110. One advantage of this approach is that it may be used on operational features within the device, which is beneficial in certain applications where validation of the volume of the functional features is necessary or desirable. Alternatively, additional features may be added to a device to enhance the refraction effect. For example, one or more circular regions (not shown) may be used to determine the amount of light that is passed through a device relative to the amount scattered or refracted, with a certain predetermined threshold of light transmission used to pass or fail devices.

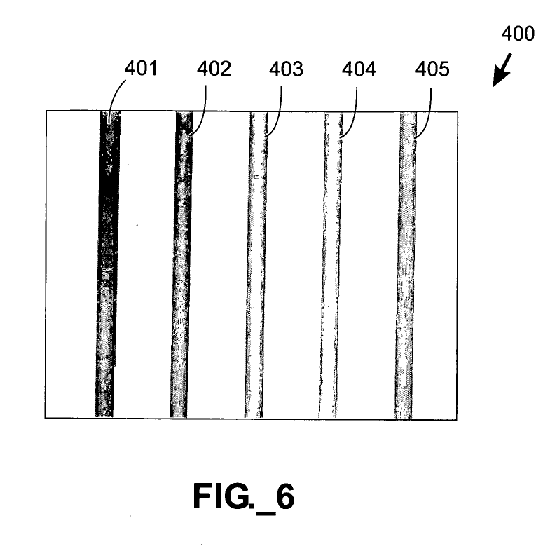

In another embodiment, functional features or detection channels within a device may be filled with a light absorbing dye. When an illumination source is used to illuminate the device, the amount of light passing through the center of the channel relative to the amount passing through the edge of the channel shows the extent of sag within the channel. FIG. 6 is a photo of a device 400 having a plurality of channels 401-405, each filled with a light absorbing dye. The optical density variation resulting from the sag present in each of the channels is visible. Such dyes may be introduced into functional features of a device. Alternatively, when the use of such dye may be undesirable due to contamination concerns, detection channels that are independent of the functional features of a device, such as those described above, may be used.

In another embodiment, a series of open detection channels in the surface of a device, independent of any functional features, may be used to detect the degree of sag present in the device. FIGS. 5A-5B illustrate a portion of a device 200 having six device layers 202-207. A detection channel 210 is defined in the fourth through sixth layers 205-207. The channel 210 could be of any desirable shape and size. Preferably, the channel 210 would have substantially the same width as the other features of the device, so that any sag detected by the channel 210 would directly correspond to any sag experienced by said features. During fabrication, any sag would in this case push the layer 204 into the hole forming a bulge 212. Because there is no protective cover to prevent access to the detection channel 210 (i.e., the detection channel 210 is an open well in the surface of the device 200), the amount of sag may be measured directly by measuring the thickness of the device 200 at the center of the detection channel 210 relative to the total thickness of the device 200.

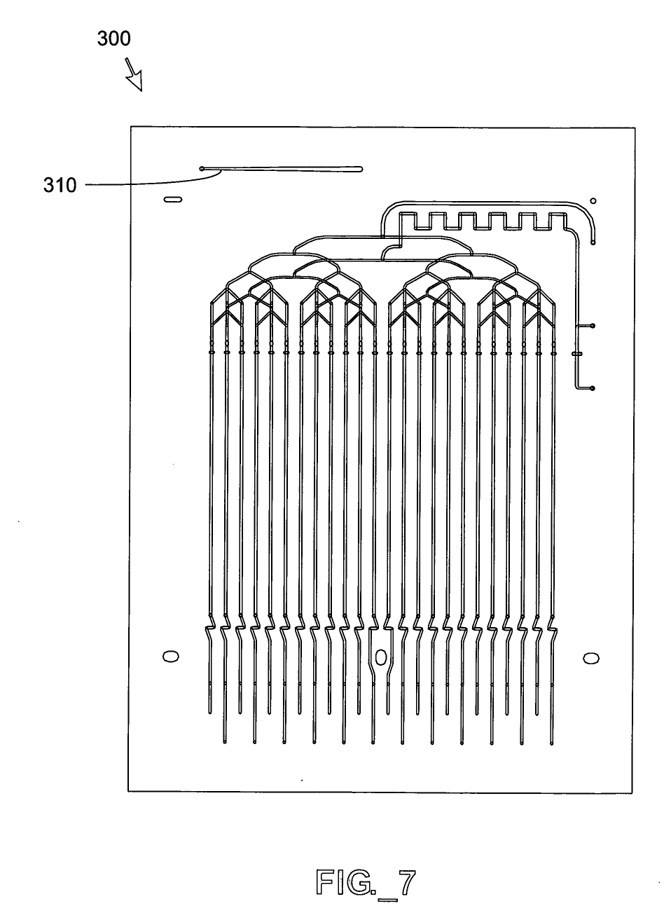

It will be readily understood by one skilled in the art that detection channels may be incorporated into more complex devices having three, six or any desirable number of layers. For example, FIG. 7 illustrates a twelve device layer microfluidic multi-column liquid chromatography device 300, similar to the device described in U.S. Patent Application Serial No. 60/415,896, filed Oct. 3, 2002, which is owned by assignee of the present application and incorporated by this reference as if fully set forth herein. The device 300 includes a detection channel 310 similar to the detection channel discussed with reference to FIGS. 1-3. Of course, other channel collapse detection structures, such as those discussed with reference to FIGS. 4-6, may be incorporated into this and other microfluidic devices as desired. Moreover, the channel collapse detection structures may be defined in any suitable device layer. Preferably, the channel collapse detection structures are defined in the device layer in which the functional features of interest are defined; however, other layers may be used. Alternatively, channel collapse detection structures may be defined in multiple device layers.

It is also to be appreciated that the foregoing description of the invention has been presented for purposes of illustration and explanation and is not intended to limit the invention to the precise manner of practice herein. It is to be appreciated therefore, that changes may be made by those skilled in the art without departing from the spirit of the invention and that the scope of the invention should be interpreted with respect to the following claims.

What is claimed is:

1. A microfluidic device comprising:
a plurality of device layers defining a plurality of operational microfluidic structures; and
a channel collapse detection structure defined in at least one device layer of the plurality of the device layers;
wherein the channel collapse detection structure is not in fluid communication with any operational microfluidic structure of the plurality of operational microfluidic structures.

2. The microfluidic device of claim 1 wherein the channel collapse detection structure comprises a substantially linear channel having a variable width.

3. The microfluidic device of claim 1 wherein the channel collapse detection structure comprises a plurality of channel segments each having a different width.

4. The microfluidic device of claim 1 wherein the channel collapse detection structure comprises an open well.

5. The microfluidic device of claim 1 wherein any device layer of the plurality of device layers is a stencil layer.

6. The microfluidic device of claim 1 wherein any device layer of the plurality of device layers comprises a polymeric material.

7. The microfluidic device of claim 1 wherein each device layer of the plurality of device layers comprises an adhesiveless polymer layer.

8. The microfluidic device of claim 7 wherein the polymer layer comprises a vinyl-based polymer.

9. The microfluidic device of claim 8 wherein the polymer layer comprises a polyolefin.

10. The microfluidic device of claim 8 wherein the polymer layer comprises polypropylene.

11. A system comprising:
the microfluidic device of claim 1;
an illumination source positioned to direct a signal through the channel collapse detection structure; and
a detector positioned to sense the signal.

12. A method for detecting a manufacturing defect in a microfluidic device, the method comprising the steps of:
providing a microfluidic device having a channel collapse detection structure; and
examining the channel collapse detection structure.

13. The method of claim 12 wherein the step of examining the channel collapse detection structure includes performing a visual examination.

14. The method of claim 12 wherein the step of examining the channel collapse detection structure further comprises the steps of:
positioning an illumination source adjacent the channel collapse detection structure; and
positioning a detector in sensory communication with the illumination source.

15. The method of claim 12 wherein the step of examining the channel collapse detection structure further comprises the steps of:
injecting a light absorbing dye into the channel collapse detection structure;
positioning an illumination source adjacent to the channel collapse detection structure; and
positioning a detector in sensory communication with the illumination source.

16. The method of claim 12 wherein:
the channel collapse detection structure is an open channel; and
wherein the step of examining the channel collapse test structure comprises measuring the depth of the open channel.
